(19) United States
(12) Patent Application Publication
(10) Pub. No.: US 2004/0049676 A1
(43) Pub. Date: Mar. 11, 2004

(54) Methods and protocols for intrusion-tolerant management of collaborative network groups

(76) Inventors: Bruno Dutertre, Mountain View, CA (US); Hassan Saidi, Menlo Park, CA (US)

Correspondence Address: Moser, Patterson & Sheridan, 595 Shrewsbury Avenue - Suite 100, Shrewsbury, NJ, 07702, US

(21) Appl. No.: 10/089,941

(22) PCT Filed: Apr. 26, 2001
(86) PCT No.: PCT/US01/13848

(51) Int. Cl. H04L 9/00

(52) U.S. Cl. 713/163; 380/277

(57) ABSTRACT

The inventive subject matter provides reliable methods and apparatus for secure communication within a network collaboration group including a VPN. Distribution of critical group data to member nodes (such as encryption keys for communication with other member nodes) is preferably handled by master nodes in a manner relatively resistant to misbehavior by current, past, or other nodes, and to outsider attacks such as replay attacks. A particular embodiment enables distribution of critical group data by master nodes to member nodes in a manner that offers confidentiality (the critical data cannot be read by eavesdropper), integrity (the receiving member node has evidence that the critical data has not been tampered with in transit), authenticity (the receiving member node has evidence that the critical data was sent by a master node), and freshness (the critical data is not a replay of a previous message). In an embodiment, communication of critical data between the master node and the member node may be encrypted with a session key. Preferably, in each round of communication between master and member, the transmitting node generates a new nonce value and embeds it in the encrypted communication, for use by the recipient in the next communication. This nonce value typically becomes the expected nonce, for purposes of the next communication. If the next communication does not contain the expected nonce value, then the communication may be readily identified and rejected by the recipient as a replay attack or otherwise illicit communication.

This application claims the benefit of U.S. provisional applications Nos. 60/247,184 and 60/247,488 both incorporated herein by reference in their entirety.

### FIELD OF THE INVENTION

The field of the invention is secure groupware management.

### BACKGROUND OF THE INVENTION

As global users including major commercial enterprises continue their migration to online network environments, the problem of vulnerability to malicious attack by “hackers” becomes more severe, and the need increases for ostensibly “private” online groups to provide strong defense against unwanted intrusion. For example, a virtual private network (VPN) is an overlay network that provides secure communication channels through an underlying (usually public) network infrastructure (such as the Internet), as a relatively inexpensive alternative to private secure lines. Communications among the members of a VPN are typically automatically encrypted using secure keys known to the members of the group, as a means of achieving the desired privacy for the members. However, even without access to the private passwords and keys held by group members of a VPN, a knowledgeable hacker may attempt to interrupt service or otherwise sabotage a VPN by electronic intrusion such as a replay attack (illicit interception, copying, and re-transmission of encrypted traffic). To preserve system integrity and availability, it is important that such attacks be easily recognized as illicit communications.

Thus, there is a need for improved systems, methods, and protocols for securing communications among members of a VPN, collaborative group, or other group.

### SUMMARY OF THE INVENTION

The present invention is directed toward systems and methods for managing collaborative network groups. Collaborating members of the network group may be classified as member nodes. Distribution of critical group data to member nodes (such as encryption keys for communication with other member nodes) is generally handled by master nodes in a manner resistant to misbehavior by current, past, or other member nodes. Distribution of critical group data is also preferred to be resistant to outsider attacks such as replay attacks. Distribution of critical group data by master nodes to member nodes advantageously offers confidentiality (the critical data cannot be read by eavesdropper), integrity (the receiving member node has evidence that the critical data has not been tampered with in transit), authenticity (the receiving member node has evidence that the critical data was sent by a master node), and freshness (the critical data is not a replay of a previous message).

In a preferred protocol, each member node is provided an encryption key (session key) that is known by the member node and its master node only, and is valid only for the duration of time that the member node remains legitimately within the group. Communication of critical data between the master node and the member node may be encrypted with the session key, in both directions. In each round of communication between master and member, the transmitting node may generate a new nonce value and may embed it in the encrypted communication, for use by a recipient in the next communication. The new nonce value typically becomes the expected nonce, for purposes of the next communication. Generally, if the next communication does not contain the expected nonce value, the communication may be readily identified and rejected by the recipient as a replay attack or otherwise illicit communication.

In a further aspect, in order to initiate a communication session in accordance with the protocol, the member node may first generate and store a nonce value that is communicated to the master node. The stored nonce value may thus be established as the expected nonce value for purposes of the next communication, i.e., the master node's response. The member and master may use a long-term key for encryption during this initiation process. The master node's response can contain a session encryption key for use in subsequent exchanges during the session, and further can contain the stored nonce value in order to verify its authenticity to the member node. The master node's response can further contain a new nonce value, for use in the next message from the member.

### BRIEF DESCRIPTION OF THE DRAWINGS

FIG. 1 is a representation of an intrusion-resistant dialogue between a member node and a master node, in accordance with one embodiment of the present invention.

FIG. 2 depicts a structure of a secure, encrypted message in accordance with one embodiment of the present invention.

### DETAILED DESCRIPTION

Network Definitions

A network “node” may be any type of device or collection of devices capable of processing instructions including (but not limited to) a cellular phone, a PDA, an intelligent household appliance, a general-purpose computer, a network server, a multi-processor cluster of computers, or a computer network such as a LAN. Network nodes are considered “interconnected” if there is a potential path for communication between them, regardless of whether that path is direct.

A collaboration group typically includes a collection of interconnected network nodes. Some collaboration groups, such as a virtual private network (“VPN”), may utilize encrypted communication channels so that group communications cannot be read and understood by nodes that are not members of the group. An example of a VPN is the Enclaves™ system created by the assignee of the present invention and described in L. Gong, Enclaves: Enabling Secure Collaboration Over the Internet,” published in Proceedings of the 6^{th} USENIX Security Symposium, pp. 149-159, San Jose, Calif. (July 1996). Enhanced VPN architectures and methods are described in a patent application entitled “Methods And Apparatus For Scalable, Distributed Management Of Virtual Private Networks”, Ser. No. ______ to be determined, filed by the assignee of the present invention on event date with the present filing. The teachings of the present invention have utility for VPNs, but may also be applied more generally to network collaboration groups regardless of whether all group communications are encrypted.

Intrusion-Tolerant Communications

A preferred embodiment of the present invention provides a method for managing a virtual private overlay (or other network collaboration group) in a manner resistant to attacks from outside the group or from misbehaving member nodes. The collaboration group typically comprises a plurality of member nodes and one or more master nodes. The master nodes are typically responsible for managing membership control tasks, such as arise when a new member node joins the group or when an existing member leaves the group. The master nodes may also be responsible for communicating critical data in that regard, such as cryptographic keys, to the member nodes. A protocol for communicating such critical data will now be described that offers resilience against replay attacks, eavesdropping, and message corruption.

The master node, and each member node that wishes to use this node as a master, may be provided with a secret session key that is essentially unique to this pair of member and master nodes, and to their communication session. Each communication of critical data between these two nodes is preferably encrypted with the session key and includes two nonce values. The first nonce value is usually already known to the recipient of the message (the expected nonce), and the second nonce value is typically a fresh nonce generated by the sender (the sender's nonce). The recipient of each such message may verify that the encrypted message includes the expected nonce value. The recipient may then acknowledge the message by replying with another message, also encrypted with the session key that includes the sender's nonce just received and a new nonce freshly generated by the recipient. This new nonce generally becomes the expected nonce for the recipient when the next communication is sent.

The term “nonce” denotes a number (or other datum) chosen from a sufficient enough distribution to ensure a relatively high probability of uniqueness. A “fresh” nonce is a newly generated nonce. The purpose of a nonce, as used herein, is generally to ensure a low probability that a would-be intruder monitoring communications within the VPN or other collaboration group will be able to launch a replay attack or other illicit infiltration attack. As used herein, a “replay attack” is an attempt to infiltrate an authentication system by a would-be intruder or some other node that records and replays previously sent valid communications.

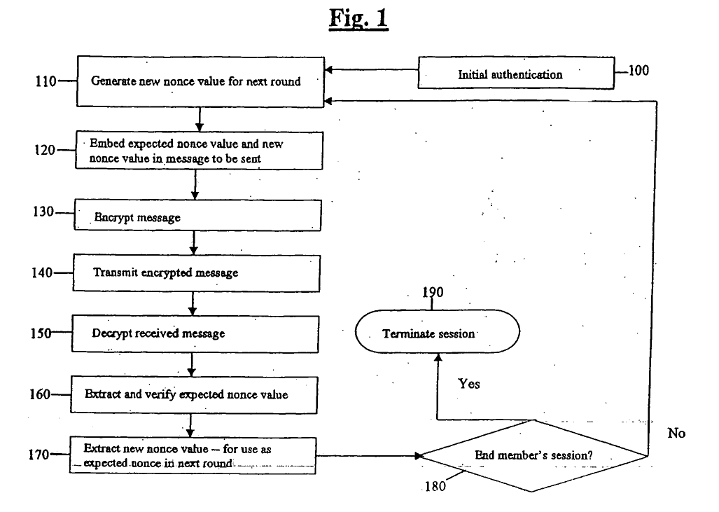

In FIG. 1, step 100, a new member node joins the group by means of a brief authentication and initialization protocol with its assigned master node. This authentication protocol is described below in detail in connection with Table 1. The authentication protocol may establish (among other things) an initial expected nonce value, known to the new member and the master node. At 110, the member (or master) node desiring to send a secure message generates a new fresh nonce value, to serve as the expected nonce value for the subsequent round of communication (i.e., in response to the message currently being sent). At 120, the new nonce and the expected nonce are included in the message to be sent, and at 130, the message is encrypted using the session key and is sent (140) to the receiving node. At 150, the message is decrypted by the receiving node. At 160, the expected nonce value is extracted from the decrypted message, and the recipient node can verify that the extracted value matches the expected value. At 170, the new nonce value is extracted by the recipient, so that it can be used by the recipient as the expected nonce for purposes of the next communication. At 180, if it is determined that the member node will leave the session at this point, then termination sequence 190 is performed, as described below in more detail in connection with Table 4. If instead there is to be another round of communication, then the recipient of the current message prepares to send a response by iterating through process 110-170 once again, but this time using the previous round's new nonce as the expected nonce. This process preferably continues repeatedly, for the duration of the session between the member and the master.

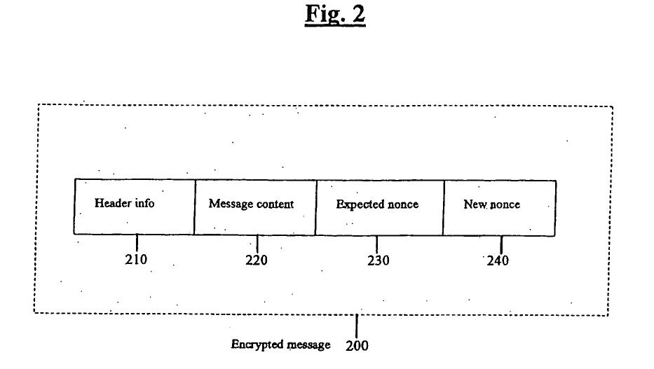

FIG. 2 illustrates the general structure of a secure message in accordance with an embodiment of the subject matter. The contents of secure message 200 are encrypted, preferably using a shared session key as described. Message contents may include:

header information 210, which may include for example an identification of the node sending the message and the recipient node for whom the message is intended, as illustrated below in connection with Tables 1-4;

main content 220, i.e., the primary subject matter communicated via the message;

expected nonce 230, i.e., the nonce value that the recipient expects to see and will examine (160) in order to verify authenticity and freshness of the message; and

new nonce 240, i.e., the value that the sender generates and establishes as the next expected nonce value to be used in a response message from the recipient.

For purposes of further illustration, we now depict in detail an example of a simplified dialogue between a master node and member node of a VPN. In this example, the master mode is represented by the letter M, and the member (client) node by the letter C. This example will illustrate how client C joins the VPN managed by master node M, receives and acknowledges group-management messages from M, and eventually leaves the VPN. The content of each group management message is not relevant to the example, rather, we are intending to illustrate that the protocol ensures that C accepts only valid group-management messages and in the order that they were sent by L. As practitioners will readily appreciate, the protocol as outlined here is a simplified version of what will typically be used in a fully featured VPN system, but is serves to illustrate some relevant aspects for providing the desired intrusion tolerance properties.

Assume in this example that each client C has a secret long-term key (e.g. a password) Pc, initially known at the outset of the example by C and by M. To join the VPN, C initiates the following sample protocol:

TABLE 1

1. C → M: AuthInitReq, C, M, {C, M, N1} Pc
2. M → C: AuthKeyDist, M, C, {M, C, N1, N2, Kc} Pc
3. C → M: AuthAckKey, C, M, {N2, N3} Kc

Thus, C requests to join the session with message 1 that contains a fresh nonce N1 and is encrypted with key Pc. On receipt of this message, M may generate a fresh session key Kc and a fresh nonce N2 and sends the key distribution message (message 2). Message 2 includes both nonces N1 and N2 as well as session key Kc, and again is encrypted by Pc. C receives and decrypts this message, checks that N1 matches the nonce sent in message 1, and extracts the key Kc. C then sends to M the key acknowledgement in message 3, which includes fresh nonce N3 (as well as N2) and is encrypted using session key Kc. If this authentication protocol succeeds, then C becomes a member of the VPN and is in possession of session key Kc.

As long as C is in session, M can send group management messages to C, and C generally will acknowledge each such message, in accordance with the repetitive process shown in FIG. 1 at 120-170. Messages and acknowledgements are encrypted with Kc, and nonces are used to protect against replay attacks. Thus, the first exchange (following authentication as described above) uses nonce N3 generated by C received by M at the end of the authentication process:

TABLE 2

1. M → C: AdminMsg, M, C, {M, C, N3, N4} Kc
2. C → M: Ack, C, M, {C, M, N4, N5} Kc

In this sample exchange, message 1 contains nonce N3 as well as fresh nonce N4 generated by master node M, and is encrypted using Kc. On receipt of message 1 by C, the presence of N3 assures C that this message is fresh (not a replayed attack), and the encryption with Kc ensures that the message originated from M. The acknowledgement (message 2) contains nonce N4 and a further nonce N5 freshly generated by C. Receipt of message 2 is evidence to M that C effectively received message 1, and M will in turn use nonce N5 in the next group management message that M sends to C.

More generally, as long as C is in session, both M and C may memorize a nonce N[2i+1] that was generated by C. This nonce is usually either the N3 communicated to M at the end of the authentication protocol (per Table 1 above), or the nonce that M received from C in the most recent acknowledgement message. A sample group management exchange is then as follows:

TABLE 3

1. M → C: AdminMsg, M, C, {M, C, N[2i+1], N[2i+2]} Kc
2. C → M: Ack, C, M, {C, M, N[2i+2], N[2i+3]} Kc

Message 1 contains N[2i+1] to prove to C that the message is not a replay, and communicates to C the fresh nonce N[2i+2] that M generates. Message 2 contains N[2i+2] to prove to M that the acknowledgement is not a replay but rather is an authentic response; and also communicates to M a new fresh nonce N[2i+3] to be used in the next exchange.

C can leave the VPN session at any time by sending M the message shown below in sample Table 4. In this message, the key Kc is used both to guarantee that the message originated from C and to prove freshness (i.e. that the message is not a replay attack). The message cannot be a replay since there can be at most one authentic closing message per session and hence per session key. No acknowledgement is needed from M. Instead, on receipt of message 1, M simply closes its session with C; key Kc is discarded; and no further group management messages are sent to C.

TABLE 4

1. C → M: ReqClose, C, M, {C, M} Kc

Further details (including a formal verification of intrusion tolerance properties, for interested practitioners) are included in the white paper entitled “Verification of Enclaves Group-Management Services”, authored by the inventors of the present invention and included in provisional U.S. application serial No. 60/247,488, incorporated herein by this reference.

Thus, specific embodiments and applications of groupware related methods and devices have been disclosed. It should be apparent, however, to those skilled in the art that many more modifications besides those described are possible without departing from the inventive concepts herein. For example, in the interests of simplicity, the illustrations of the preferred embodiments described above generally refer to the new nonce value in a prior message being used as the expected nonce value in a following message. However, it will be clear to those of skill in the art that the current expected nonce value could equivalently be set to a value derived from the prior new nonce value in accordance with some function, provided that the two nodes exchanging the message know and agree that such function will be used. Likewise, many other variations and enhancements of the protocol are possible and will be apparent to practitioners, consistent with the spirit of the invention. The inventive subject matter, therefore, is not to be restricted except in the spirit of the following claims.

What is claimed is:

1. A secure method of transmitting a message between a sender node and a recipient node within a network collaboration group, the sender and the recipient sharing a secret encryption key and an expected nonce value comprising:
generating a new nonce value known to the sender;
encrypting the message including the expected nonce value and the new nonce value, using the encryption key;
transmitting the encrypted message from the sender to the recipient; and
verifying, by the recipient, that the encrypted message includes the expected nonce value.

2. The method of claim 1, further comprising:
generating a second new nonce value, known to the recipient node;
transmitting a secure response from the recipient to the sender by repeating the method of claim 1, but this time using the second new nonce value in place of the new nonce value and using the new nonce value in place of the expected nonce value.

3. The method of claim 2, wherein the method is further repeated for one or more subsequent rounds of secure communication between the sender and the recipient, such that for each round the new nonce value of the previous message is used as the expected nonce value for the current message.

4. The method of claim 1, wherein the network collaboration group is a virtual private network.

5. The method of claim 1, wherein the sender is a key managing master node and the recipient is a member node of the collaboration group.

6. The method of claim 1, wherein the recipient is a key-managing master node and the sender is a member node of the collaboration group.

7. The method of claim 1, wherein the method is used with a key-managing master node in order to perform an authentication process for opening a collaboration group session with a new member node.

8. The method of claim 7, wherein the method is used with the new member as the sender and the master node as the recipient, in order to initiate the authentication process.

9. The method of claim 7, wherein the method is used with the master node as the sender in order to distribute a session encryption key from the master to the member.

10. The method of claim 9, wherein a long-term password key is used as the encryption key in order to perform the authentication process, and the session key is used as the encryption key for one or more subsequent communications between the new member and the master.

11. The method of claim 10, wherein the session key is revoked by the master upon receipt of a termination message from the member.

12. The method of claim 1, further including receiving a copy of a prior message being transmitted as a replay attack, and rejecting the replay as illicit at least in part because the replay does not contain the current expected nonce value.

13. A system for managing communications within a network collaboration group, comprising:
means for generating a new nonce value;
means for incorporating an expected nonce value and the new nonce value in a message to be transmitted;
means for encrypting the message;
means for transmitting the encrypted message from a sender node of the group to a recipient node of the group; and
means for verifying, by the recipient node, that the encrypted message includes the expected nonce value.

14. The system of claim 13, wherein the means for incorporating are operable to use the new nonce value, contained in a most recent previous message from the sender to the recipient, as the expected nonce value in a current message from the recipient to the sender.

15. The system of claim 13, wherein the network collaboration group is a virtual private network.

16. A data-carrying signal for transmitting information securely between a master node and a member node of a network collaboration group, the signal being encrypted using an encryption key shared by the master and the member, the signal comprising:
the information to be transmitted;
an expected nonce value known to the master and the member; and
a new nonce value, different than the expected nonce, provided by a sender of the signal.

17. The data-carrying signal of claim 16, wherein the expected nonce value in the current transmission is obtained from the new nonce value contained in a most recent previous transmission from the sender to the recipient.

18. A method for transmitting secure messages between a master node and a member node of a network collaboration group comprising:
encrypting-messages using a key shared by the master and the member, so as to protect confidentiality of the message; and
embedding a plurality of updated nonce values within said encrypted messages so as to provide verifiable integrity, authenticity, and freshness for each of said messages.
